(19) United States
(12) Patent Application Publication
(10) Pub. No.: US 2023/0121407 A1
(43) Pub. Date: Apr. 20, 2023

(54) RESOURCE PROVISIONING

(71) Applicant: JPMorgan Chase Bank, N.A., New York, NY (US)

(72) Inventors: Dan Herington, Frisco, TX (US); Russell E. Colwell, Tampa, FL (US); David M Lin, Addison, TX (US); Swapna Adusumilli, Irving, TX (US); Taylor Madden Cherry, Justin, TX (US); Jose A. Rosado, West Windsor, NJ (US)

(73) Assignee: JPMorgan Chase Bank, N.A., New York, NY (US)

(21) Appl. No.: 17/970,362

(22) Filed: Oct. 20, 2022

Related U.S. Application Data
(60) Provisional application No. 63/257,852, filed on Oct. 20, 2021.

(51) Int. Cl. G06F 9/50

(52) U.S. Cl. CPC G06F 9/5038; G06F 9/5044; G06F 9/5033; G06F 2209/5011

(57) ABSTRACT

In one example, a system with a processor operable to cause operations to optimize resources based on user-specified parameters is disclosed. A provisioning request to provision resources from multiple resource pools is received. The provisioning request can include the user-specified parameters. The system may determine state data about the resource pools by using an API that interfaces with the resource pools. The system then determines the resource pools that can satisfy the provisioning request based upon the state data and how efficiently each of the resource pools satisfy the provisioning parameters. The system then provisions resources on a resource pool that has been determined to be capable of satisfying the provisioning request.

### BACKGROUND

Resource provisioning can be referred to as the process of managing and deploying resources and assets. A resource can be any supply or source that can be utilized to fulfil a particular task. In the context of computing for example, a rack of equipment with multiple clusters may exist.

Compute resources may be desired from any one or more of the cluster resources to execute a particular job. Another example of a resource may relate to event venues, etc. Multiple event venues with different attributes may exist. Each event venue may be a resource that can be selected to convene a particular event.

### BRIEF DESCRIPTION OF THE DRAWINGS

Examples of the disclosure will be rendered by reference to specific examples thereof which are illustrated in the appended drawings. The drawings illustrate only particular examples of the disclosure and therefore are not to be considered to be limiting of its scope. The principles herein are described and explained with additional specificity and detail through the use of the accompanying drawings in which:

FIG. 1 illustrates a resource provisioning system according to an example of the present disclosure.

FIG. 2 illustrates a computing resource provisioning system according to an example of the present disclosure.

FIG. 3 illustrates a resource provisioning method according to some examples of the present disclosure.

FIG. 4 illustrates a resource provisioning system according to an example of the present disclosure.

FIG. 5 illustrates a ranked list of resource pools provided to a user to provide a resource allocation method according to some examples of the present disclosure.

FIG. 6 illustrates example instructions stored on an example non-transitory computer-readable storage medium to implement resource provisioning according to some examples of the present disclosure.

FIG. 7 illustrates an example computing system to implement a rank-based resource provisioning service that provides resource allocation according to some examples of the present disclosure.

### DETAILED DESCRIPTION

Resource provisioning is often inefficient as many resource provisioning algorithms may simply assign an available resource to a resource provisioning request if the available resource is sufficient to meet the resource provisioning request. However, the selected available resource may have capacity in excess of the resource provisioning request and other available resources may also have sufficient capacity. In such cases, the total resource capacity available is not used efficiently and may not be available for subsequent resource provisioning requests. Most of the time, in the computing context for example, it is known that servers can operate at 10%˜50% of their full capacity, which can cause additional acquisition costs on overprovisioning.

Accordingly, examples of the present disclosure address the foregoing by implementing a system including a processor and computer-readable media having instructions for efficient resource provisioning in response to a provisioning request. The system receives the provisioning request from a user to provision resources from a plurality of resource pools. The provisioning request itself may include user-specified parameters for the desired resources. The system may determine state data about the resource pools by using an API (Application Programming Interface) that interfaces with the resource pools.

The system may then determine the resource pools that can satisfy the provisioning request based upon the state data and how efficiently each of the resource pools satisfy the specified provisioning parameters. The system then provisions resources on a resource pool that has been determined capable of satisfying the provisioning request.

In an example, the system may rank the resource pools that can satisfy the provisioning request based upon the state data and how efficiently each of the resource pools satisfy the user-specified parameters. The system may also iteratively provision resources from the highest ranked resource pool to the lowest ranked resource until the requested resource provisioning is effectuated.

In one example, the requested provisioning is attempted on the highest ranked resource. If provisioning is unsuccessful, using the highest ranked resource, provisioning is then attempted on the next highest ranked resource, and so on until the requested provisioning is effectuated. For some such examples of the present disclosure, the resource ranking may be dynamically updated based upon changes to the capacity of any of the available resources.

The resource provisioning request can relate to many resource types and examples of this disclosure may be used to optimize the allocation of pooled resources. In some examples, the resource provisioning request may be for computing resources. The computing resources may include a plurality of clusters, each computing cluster may include at least two servers, and the state data about resources on the computing cluster is determined via one or more APIs (Application Programming Interface). In an example, the resource pool may relate to event venues, where the provisioning parameters may relate to cost, location, configurability and size of an event venue.

In this manner, the present disclosure facilitates efficient resource provisioning. An available resource is not simply assigned to a resource provisioning request if the available resource is sufficient to meet the resource provisioning request. Instead, the present disclosure analyzes all available resources that may have sufficient capacity and determines the most efficient provisioning resource. The provisioning resources may also be ranked as noted above.

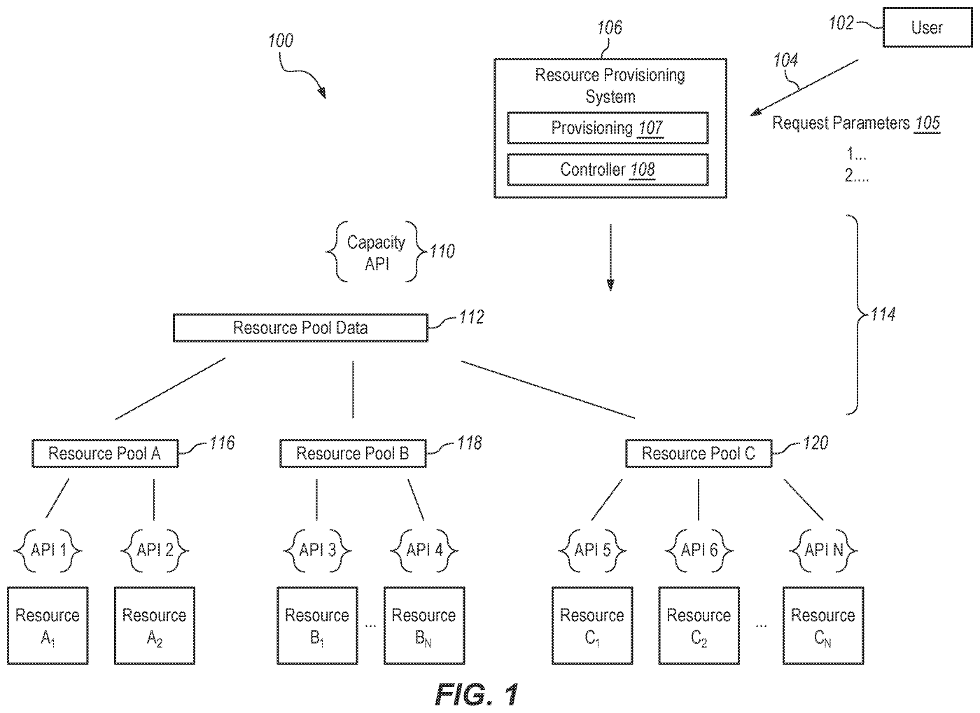

FIG. 1 illustrates a resource provisioning system 100 according to an example of the present disclosure.

In FIG. 1, a user 102 can employ the resource provisioning system 100 to provision resources from any one or more of various resource pools including a resource pool A 116, a resource pool B 118 and a resource pool C 120. Although not shown, resource provisioning system 100 may include a communication network to facilitate resource provisioning; the communication network itself enables the transmission and receipt of data between two or more points. The communication network may be the Internet, a WAN (wide area network), LAN (local area network), an Enterprise Data Network, etc., or a combination of two or more communication systems.

Here, resource provisioning system 100 includes a resource provisioning system 106 that includes a controller 108 and a provisioning module 107 that may include program instructions to efficiently provision resources based on user-specified parameters. Although not shown, resource provisioning system 106 itself may include one or more web servers, application servers, database servers and the like.

The resource provisioning system 100 further includes a capacity API (Application Programming Interface) 110 and a resource pool data 112 module. Capacity API 110 may include program instructions to interface with resource pool data 112 module to retrieve state data and to interface with resource provisioning system 106 to hand off the retrieved state data. The resource pool data 112 itself can retrieve and store resource state data for each one of resource pool A 116, resource pool B 118 and resource pool C 120. The type of resource state data that is stored is dependent upon the particular resource that is offered as discussed below.

Each resource pool A 116, resource pool B 118 and resource pool C 120 can aggregate a particular resource type from multiple sources into a single resource pool. For example, for resource type A, the resource pool A 116 aggregates two sources namely resource A₁ and resource A₂ into a single resource pool A 116 via respective APIs namely API 1 and API 2.

The resource pool B 118 can similarly aggregate multiple sources of the resource B into a single resource pool. That is, resource pool B 118 aggregates resource B₁ . . . B_{N} into a single resource pool B 118 via respective APIs API 3 and API 4. The same can be said for resource pool C 120 that aggregates resource C₁, C₂ . . . C_{N} into a single resource pool C 120 via respective APIs API 5, API 6 and API N.

In this manner, the resource pool A 116, the resource pool B 118 and the resource pool C 120 can significantly increase the amount of resource offerings regardless of the ownership, distance, etc. of the resource. Thus, as shown, each resource A₁, A₂, B₁ . . . B_{N} and C₁, C₂ . . . C_{N} is separate and is offered by an independent service provider that can be geographically remote and distant from each other and from the corresponding resource pool. For example, resource C₁ can be a resource emanating from an event venue provider such as a hotel that is separate and geographically remote from resource C₂, which can be another independent provider such as a stadium that is thousands of miles away from resource C_{N}. Resource C_{N} itself can be an event planning service that aggregates event venue data from multiple data sources.

In this manner, the resource pool C 120 can combine all of the resources using APIs such as API 5 to retrieve event venue state data from resource C1 (i.e., the hotel), use API 6 to retrieve event venue state data from resource C2 (i.e., the stadium and employ API N to retrieve event venue data from resource C_{N} (i.e., the event planner). The state data information that is retrieved via all of the APIs is then transmitted to the resource pool data 112.

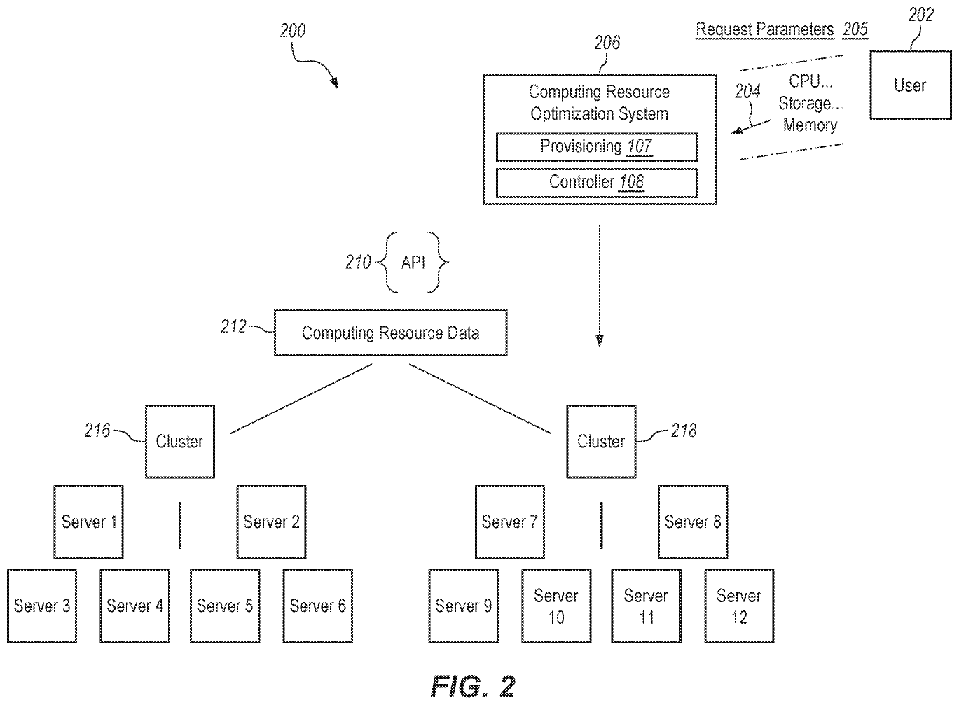

In operation, user 102 may desire to provision resources. The user 102 begins by transmitting a resource provisioning request 104 to the resource provisioning system 106. In one example, the provisioning request 104 may relate to computing resources. This computing example will be further discussed with reference to FIG. 2. As another example, the provisioning request 104 may relate to provisioning an event venue. The provisioning request 104 is not limited to the aforementioned examples. As another example, the provisioning request 104 may relate to provisioning freight transportation and so forth.

Irrespective of the resource type, the provisioning request 104 may include user-specified parameters 105 that identify the attributes or constraints of the resource that is being requested. A provisioning or user-specified parameter is any constraint, requirements, preferences and the like that are provided by the user, although for some examples, provisioning parameters may be predetermined and stored for each user in a datastore (not shown).

The user-specified parameters 105 depend upon the type of requested resource. For example, if the provisioning request 104 is for an event venue, the user-specified parameters 105 may include the date and time for the event venue, the cost or budget, audio/visual/built-in streaming/live feed capabilities, requirement for space reconfigurability. Some user-specified parameters may be specified as options that can be used by provisioning system 106 to further efficiently provision resources based on received state data and the user-specified parameters 105. Here, such options may include catering options, transportation options, distance from major attractions, etc.

As another example, if the provisioning request 104 is for transportation freight, the user-specified parameters 105 may include cost, timing, ground freight transportation, ocean freight transportation, air freight transportation, hot shot, truckload, LTL (less than truckload), pool distribution, same day, overnight, airport-to-airport, charter, etc.

Upon receipt of the provisioning request 104, resource provisioning system 106 causes an API call to be transmitted to resource pool data 112. In one implementation, the API call is to request state data for the requested resource. The term “state data” is real-time data from a resource or resource pool about the status (i.e., available or unavailable) of the resource and the resource attributes that correspond to the user-specified parameters 105. For example, state data for an event venue provisioning request may be “available,” “cost,” “audio/visual capable,” “space is configurable,” and “square footage is . . . .”

Responsive thereof, capacity API 110 then retrieves the requested state data from resource pool data 112 for the appropriate resource pool A 116, B 118 or C 120. Here, as noted above, capacity API 110 may include program instructions to interface with resource pool data 112 module to retrieve state data and to interface with resource provisioning system 106 to hand off the retrieved state data. The state data is itself obtained from the resource pools A 116, B 118 and C 120 that are updated in real-time via their corresponding APIs API 5, API 6 and API N which respectively retrieve state data from C₁, C₂ and C_{N}.

Responsive to the request for state data, capacity API 110 returns the requested state data to provisioning system 106. Here provisioning system 106 then determines for the requested resource type, which resource of the resource pools A 116, B 118 or C 120 efficiently satisfies the provisioning request 104 based on the user specified parameters 105 and the state data that is returned from the resource pool data 112.

As used herein, efficiency is how well free resources are utilized, or getting the most out of available resources. The algorithm used to maximize efficiency may differ depending on the type of resources that is provisioned. The algorithm to maximize efficiency in the provisioning of computing resources is different from the algorithm to maximize efficiency in the provisioning of event venue resources. In one example, a request may be allocated across multiple resource pools. In another example, a request may be allocated to a single resource pool.

Each resource pool has both consumed resources and available (free) resources. So, a request may fit in all pools, but it may fit better in a particular one—for example because it exactly fills up a pool. This full pool would maximize efficiency subject to other parameters being met.

It would be inefficient to leave resources unused because there are only small amounts of resource available in all pools. This would result in failure of provisioning because no pool has sufficient resources, but there may be sufficient resources across multiple pools. In such a case, the request is allocated across multiple resources.

In FIG. 1, the provisioning module 107 of resource provisioning system 106 then ranks the resource pools capable of satisfying the provisioning request based upon how efficiently each of the resource pool satisfies the provisioning request. In one example, a ranked list may be returned to user 102. The user 102 then attempts provisioning, beginning from the highest ranked resource to the next highest ranked resource until the requested provisioning is fulfilled. In this manner, as will be further discussed below, the present disclosure can facilitate provisioning of resources, irrespective of the resource type based on ranking and how efficiently the ranked resource pools can fulfill a provisioning request.

FIG. 2 illustrates a computing resource provisioning system 200 according to an example of the present disclosure.

In FIG. 2, unlike the resource provisioning 100 of FIG. 1 that can be utilized for any resource, here, a user 202 employs computing resource provisioning system 200 only to provision computing resources from one or more computing clusters, namely computing cluster 216 and computing cluster 218. The computing cluster 216 includes six servers namely server 1, server 2, server 3, server 4, server 5 and server 6. The nodes can be viewed as a single computer system with each node running its own instance of an operating system. In other words, computing cluster 216 aggregates a plurality of computing server resources.

Similarly, the computing cluster 218 also includes six servers namely server 7, server 8, server 9, server 10, server 11 and server 12, all of which can also be viewed as a single system, with each node executing an instance of an operating system. In one implementation, all servers are located in the same data center. In another implementation, the servers can be remotely located from each other.

As shown, each one of computing cluster 216 and computing cluster 218 is communicably coupled to a computing resource data module 212. The computing resource data module 212 can receive and store state data about available resources in the computing clusters 216 and 218. The state data information may be dynamically updated in real-time as the information changes. This dynamic update can be via a monitoring system that tracks the changes in state data. Or the dynamic update can occur at the time of the provisioning request. In this manner, resource information can be updated to accurately identify available resources when needed by user 202.

In FIG. 2, computing resource provisioning system 200 further includes an API (Application Programming Interface) 210 having program instructions to interface with computing resource data module 212 to retrieve state data, and then return that state data to a computing resource optimization system 206. API 210 may be based on any coding language such as Java, JavaScript, etc., and can be based on any architecture such as REST, SOAP, GraphQL, etc.

As implied by its name, computing resource optimization system 206 can optimize resource provisioning such that computing cluster 216 efficiently satisfies the provisioning request 204 relative to computing cluster 218 based on the user specified parameters 205 and the state data that is received via API 210. The reverse can also occur, that is, computing resource optimization system 206 can optimize resource provisioning such that computing cluster 218 efficiently satisfies the provisioning request 204 relative to computing cluster 216 based on the user specified parameters 205 and the state data.

In operation, user 202 desiring to provision computing resources, begins by transmitting a resource provisioning request 204 to the computing resource optimization system 106. Here, the resource provisioning request 204 may include user-specified parameters 205 to be met by the computing cluster 216 or 218. As shown, the user-specified parameters include CPU utilization, storage and memory requirements. The user-specified parameters can be specified in particular units or quantities or measurements of the corresponding resource. For example, CPU utilization may be specified in CPU units, e.g., 2 CPU units. As another example, memory may be specified in MiB, e.g., 256 MiB.

After the provisioning request 204 is received, the computing resource optimization system 206 causes an API call to be transmitted to computing resource data module 212 to request state data for the provisioning request 205. Responsive thereof, the computing resource optimization system 206 in conjunction with API 210 retrieves the requested state data from computing resource data module 212. The computing resource optimization system 206 which one of computing cluster 216 and computing cluster 218 can efficiently satisfy the provisioning request 204 based on the user specified parameters 205 and the state data.

If for example, computing cluster 218 is determined to be the best resource to efficiently satisfy the provisioning request 204, the computing resource optimization system 206 then provisions the computing resources on the computing cluster 218. The provisioning may allocate an amount of computing resources from either at least server 7 (for example) or both at least server 7 and server 8 (for example) of computing cluster 218.

The computing resource optimization system 206 may also rank the computing resources of computing cluster 216 and computing cluster 218 based on the resources' capability to satisfy the provisioning request 204 based upon how efficiently each computing cluster satisfies the specified provisioning parameters 205 namely CPU utilization, storage and memory. The computing resource optimization system 206 may then iteratively provision from the highest ranked resource pool to the lowest ranked resource until the requested resource provisioning is effectuated.

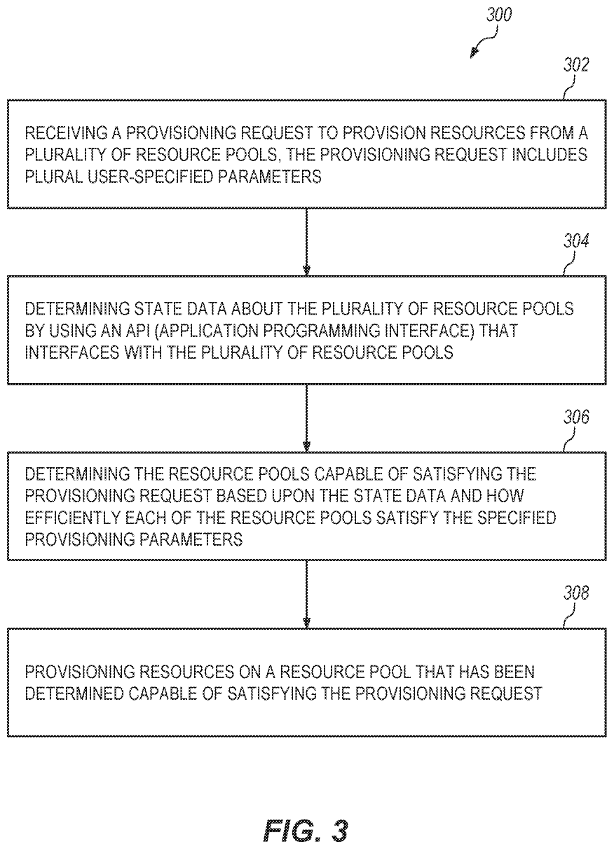

FIG. 3 illustrates a resource provisioning method 300 according to some examples of the present disclosure.

In one example, method 300 may be implemented by a resource provisioning system 106 of FIG. 1 in conjunction with one or more APIs to provide dynamic and efficient allocation of resources.

At block 302, method 300 involves receiving a provisioning request (e.g., 104, FIG. 1) to provision resources from a plurality of resource pools (e.g., resource pools A and B). The provisioning request may include plural user-specified parameters (e.g. 105, FIG. 1).

At block 304, method 300 entails determining state data about the plurality of resource pools by using an API (e.g. 110, FIG. 1) that interfaces with the plurality of resource pools.

At block 306, method 300 determines the resource pools (e.g. resource pool A or resource pool B or both) that can satisfy the provisioning request based upon the state data and how efficiently each of the resource pools satisfy the specified provisioning parameters. In one example, the provisioning parameters may be weighted as one factor against a historical utilization level that is stored in a database. The historical utilization level may be a storied history of prior actual utilization of allocated resources by a user.

At block 308, method 300 involves provisioning resources on a resource pool that has been determined capable of satisfying the provisioning request. Although not shown, method 300 may also provision resources on the resource pool by allocating an amount of resource from the resource pool. Method 300 may rank the resource pools according to how well the resource pools satisfy the provisioning request. In some examples, method 300 may iteratively provision from the highest ranked resource pool to the lowest ranked resource until the requested resource provisioning is effectuated.

Thus, examples of the present disclosure enable a dynamic resource provisioning service in which a provisioning request is not restricted to a specific resource pool but for some examples, is attempted iteratively on a ranked set of resources from a resource pool until provisioning is successful.

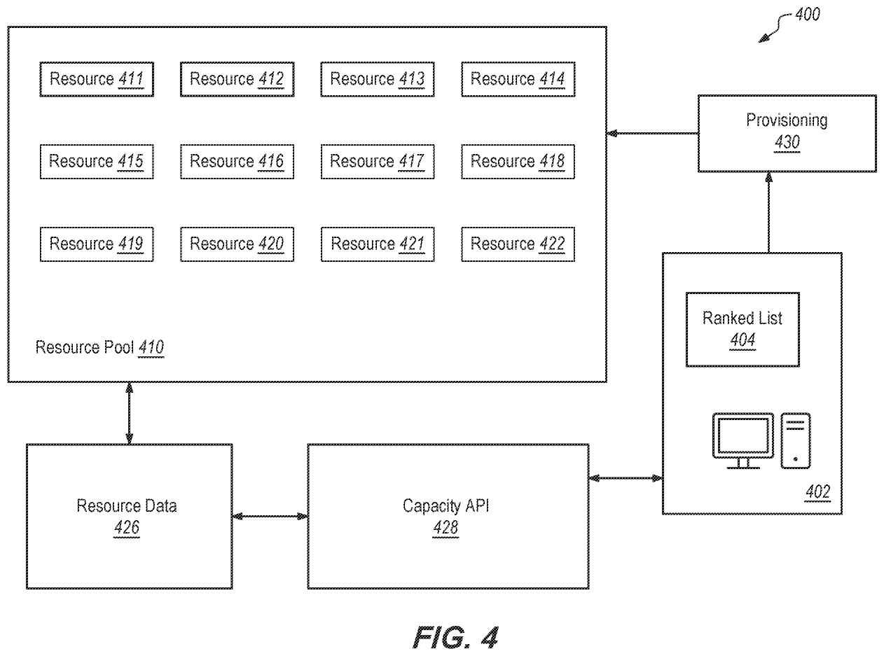

FIG. 4 illustrates a provisioning service 400 according to some examples of the present disclosure.

System 400, as shown in FIG. 4, includes a resource pool shown, for example, as resource pool 410. The resource pool 410 may include many resource pools, shown for example as resource pools 411-422. Capacity data is determined for each resource. For example, resource data 426 may store resource capacity data for each of resource pools 411-422. The resource capacity data may include data regarding any pertinent aspect of the resource pool.

A user 402 makes a resource provisioning request. The provisioning request specifies provisioning parameters which may be in regard to constraints, preferences, etc. that may be pertinent to the resource. For example, where the resource requested is conference room space, the resource capacity data may include size, location, availability, and configurability, audio/video capable, among others. Or, for example, where the resources requested are computing resources, the resource capacity data may include CPU, available memory, and available storage.

The capacity API 428 receives the provisioning request and provisioning parameters. The capacity API 428 queries the resource data 426 for capacity data for each of the resource pools to determine which resource pool is capable of satisfying the provisioning request. The resource capacity data may be updated dynamically based upon present use and availability. The capacity API 428 also determines which of the provisioning parameters may be more critical to a particular provisioning request.

The capacity API 428 ranks the resource pools capable of satisfying the provisioning request based upon how efficiently each of the resource pools satisfies the provisioning request. The capacity API 428 returns the ranked list 404 to the user 402. The ranked list may be dynamically updated based upon changes to the capacity of one or more of the resource pools.

The user 402 then attempts provisioning 430 on the highest ranked resource pool. If the provisioning 230 on the highest ranked resource pool fails, the user 402 attempts provisioning on the next highest ranked resource pool and so on until the requested provisioning is effectuated.

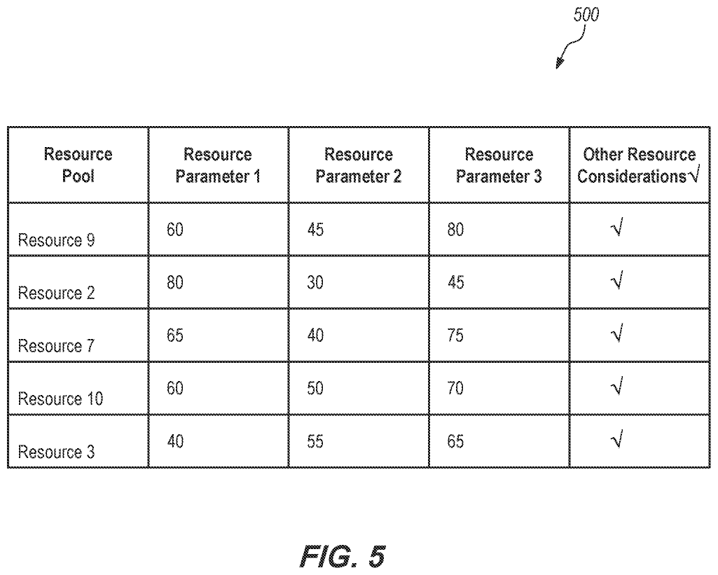

FIG. 5 illustrates a ranked list of resource pools provided to a user to effectuate a resource allocation method according to some examples of the present disclosure.

The ranked list 500, shown in FIG. 5 may include all of the available resources that may be used to effectuate a requested provisioning. The resource pools, shown for example, as resources 9, 2, 7, 10 and 3 are ranked in order of how effectively each resource pool can effectuate the requested resource provisioning based upon user-specified parameters of the resource provisioning request.

For each of the ranked resource pools, parameter values may be indicated for each user-specified parameter, for example, as shown, Parameter 1, Parameter 2, and Parameters 3. The resource pools are ranked in order of how efficiently each resource pool can effectuate the requested resource provisioning. The ranked list is returned to the user.

As shown in FIG. 5, the resource pools are ranked, for example, 9, 2, 7, 10, and 3. The user may then select the highest ranked resource pool (e.g., resource pool 9) and attempt resource provisioning. If the provisioning on the highest ranked resource pool fails, provisioning is attempted on the next highest ranked resource pool (e.g., resource pool 2), and so on until the requested provisioning is effectuated.

In FIG. 5 all of the ranked resource pools may meet any additional resource considerations as specified by the resource provisioning request. As discussed above, for examples where the resources are conference rooms, additional resource parameters that may be considered are cost and amenities, among others. For examples where the resources are computing resources, such additional resource considerations may include available IP addresses and affinity/anti-affinity rules, among others.

The ranked list may be dynamically updated with the ranking and the resource pools included in the ranking dynamically changing based upon changes to the capacity of one or more of the resource pools. It will be appreciated, from the above discussion, that examples of the present disclosure may be applicable to many different types of resource pools and to any number of resource pools each having any number of resources.

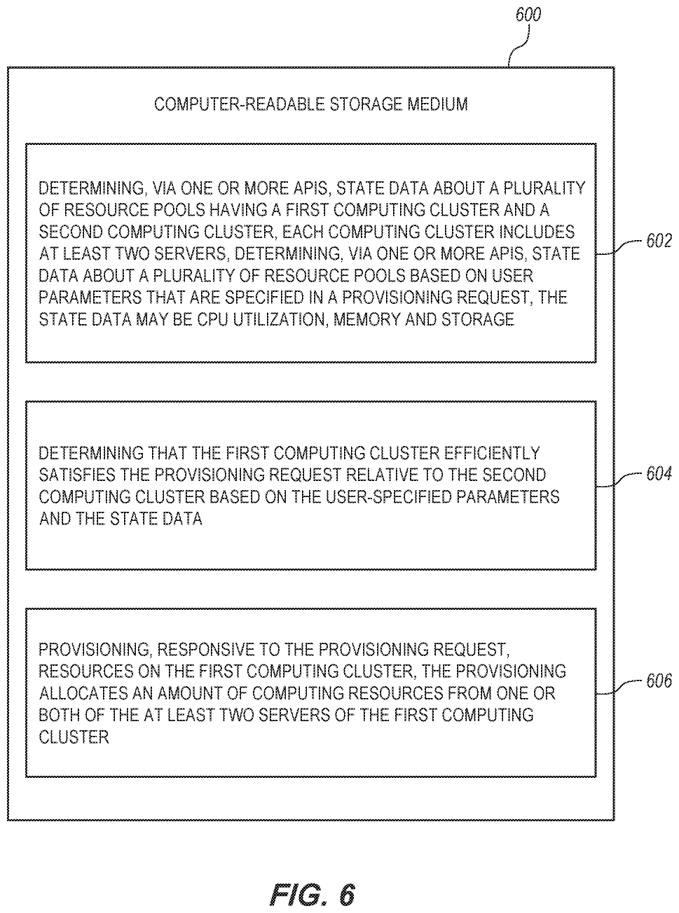

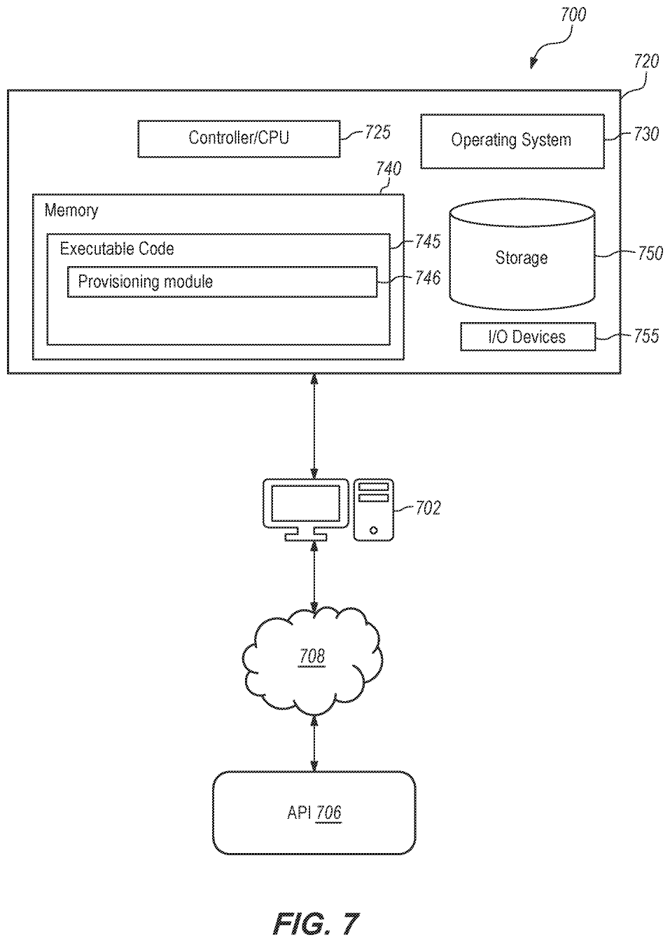

FIG. 6 illustrates example instructions stored on an example non-transitory computer-readable storage medium 600 to implement resource provisioning according to some examples of the present disclosure. The instructions executed by one or more processors 725 (FIG. 7) cause the one or more processors 725 to perform operations to perform efficient resource provisioning.

As shown, computer-readable medium 600 may include instructions 602, instructions 604 and instructions 606. Instruction 602 may determine, via one or more APIs (e.g. 210, FIG. 2, 110, AP 1, AP 2, FIG. 1), state data about a plurality of resource pools (e.g., 216, 218, FIG. 2) having a first computing cluster and a second computing cluster. Each computing cluster includes at least two servers (e.g., server 1, server 2, FIG. 2). The determining, via one or more APIs, state data about a plurality of resource pools is based on user parameters (e.g., 205, FIG. 2) that are specified in a provisioning request (e.g. 204, FIG. 2). The state data may comprise CPU utilization, memory and storage, for example.

Instruction 604 may determine that the first computing cluster efficiently satisfies the provisioning request relative to the second computing cluster based on the user-specified parameters and the state data.

Instruction 606 may provision, responsive to the provisioning request, resources on the first computing cluster, wherein the provisioning allocates an amount of computing resources from one or both of the at least two servers of the first computing cluster.

FIG. 7 illustrates an example computing system to implement a rank-based resource pool provisioning service according to some examples of the present disclosure. The computing system 700 includes computing system 702 which may be communicatively coupled to a rank-based provisioning API 706 via a network 708.

As shown in FIG. 7, each of the computing systems 702 may include computing component 720. Computing component 720 may include a controller/CPU 725 that may be, for example, a CPU, a chip or any suitable computing or computational device. Computing component 720 may include an operating system 730, a memory 740, executable code 745, and a storage system 750 that may include input/output devices 755.

Controller/CPU 725 may carry out methods described herein and/or to execute various modules. Operating system 730 may be, or may include, any code to control or manage computing component 720. This may include scheduling execution of software programs or enabling software programs or other modules or units to communicate. For some examples of the disclosure, the computing component 720 may include a computing device that does not use an operating system (e.g., a microcontroller, ASIC, FPGA, or SOC).

Memory 740 may be implemented in various forms including random access memory (RAM), read-only memory (ROM), volatile or non-volatile memory, etc. Memory 740 may be a computer-readable non-transitory storage medium. Executable code 745 may be any executable code, e.g., an application, a program, or a process.

Storage system 750 may be or may include, for example, a hard disk drive, flash memory, a micro controller-embedded memory, etc. Content may be stored in storage system 750 and may be loaded from storage system 750 into memory 740 where it may be processed by controller/CPU 725. Input/output devices 755 may include any suitable input devices such as a keyboard/keypad, mouse and any suitable output devices such as displays or monitors.

As discussed above, examples of the present disclosure may include a computer-readable medium, which when executed by a processor may cause the processor to perform operations disclosed herein. According to examples of the present disclosure, executable code 745 may include executable code implementing a rank-based provisioning module 746 which may provide some or all features of a rank-based provisioning service.

According to examples of the disclosure, the rank-based provisioning module 746 or the rank-based provisioning API 706 may periodically monitor and analyze resource pools (or resources in other examples). This analysis may be provided throughout a network of computing systems so that all of the computing systems are aware of the availability of resources.

Furthermore, in some examples, some modules may be implemented in firmware and/or hardware including, but not limited to, one or more application-specific integrated circuits (ASICs), etc. Some or all of the modules, systems and data structures may also be stored (e.g., as software instructions or structured data) on a non-transitory computer-readable storage medium, such as a hard disk or flash drive or other non-volatile storage device, volatile or non-volatile memory.

While the above is a complete description of specific examples of the disclosure, additional examples are also possible. Thus, the above description should not be taken as limiting the scope of the disclosure which is defined by the appended claims along with their full scope of equivalents.

1. A non-transitory computer-readable media having instructions thereof which when executed by one or more processors cause the one or more processors to perform operations to optimize resources, the operations comprising:
determining, via one or more APIs, state data about a plurality of resource pools having a first computing cluster and a second computing cluster, wherein each computing cluster includes at least two servers, wherein determining, via one or more APIs, state data about a plurality of resource pools is based on user parameters that are specified in a provisioning request, wherein the state data comprises CPU utilization, memory and storage;
determining that the first computing cluster efficiently satisfies the provisioning request relative to the second computing cluster based on the user-specified parameters and the state data; and
provisioning, responsive to the provisioning request, resources on the first computing cluster, wherein the provisioning allocates an amount of computing resources from one or both of the at least two servers of the first computing cluster.

2. The non-transitory computer-readable media of claim 1 wherein the operations further comprise ranking the resource pools that can satisfy the provisioning request based upon the state data and how efficiently each of the resource pools satisfy the user-specified parameters.

3. The non-transitory computer-readable media of claim 2 wherein the operations further comprise iteratively provisioning from the highest ranked resource pool to the lowest ranked resource until the requested resource provisioning is effectuated.

4. The non-transitory computer-readable media of claim 1 further comprising dynamically updating the state data in real-time.

5. A system comprising:
one or more processors; and
logic encoded in one or more non-transitory computer-readable storage media for execution by the one or more processors and when executed operable to cause the one or more processors to perform operations to optimize resources, the operations comprising:
receiving a provisioning request to provision resources from a plurality of resource pools, wherein the provisioning request includes plural user-specified parameters;
determining state data about the plurality of resource pools by using an API (Application Programming Interface) that interfaces with the plurality of resource pools;
determining the resource pools capable of satisfying the provisioning request based upon the state data and how efficiently each of the resource pools satisfy the specified provisioning parameters; and
provisioning resources on a resource pool that has been determined capable of satisfying the provisioning request.

6. The non-transitory computer-readable media of claim 5 wherein the operations further comprise ranking the plurality of resource pools that can satisfy the provisioning request based upon the state data and how efficiently each of the resource pools satisfy the user-specified parameters.

7. The non-transitory computer-readable media of claim 6 wherein the user-specified parameters are for CPU, memory and storage.

8. The non-transitory computer-readable media of claim 6 wherein the state data is for CPU, memory and storage.

9. The non-transitory computer-readable media of claim 5 wherein the provisioning request is for an event venue.

10. The non-transitory computer-readable media of claim 5 wherein the user-specified parameters are for cost, location, video, audio, catering of an event venue.

11. The non-transitory computer-readable media of claim 5 wherein the provisioning resources allocates an amount of resource from the resource pool that is capable of satisfying the provisioning request.

12. The non-transitory computer-readable media of claim 5 wherein the operations further comprise ranking the resource pools according to how well the resource pools satisfy the provisioning request.

13. A method for resource provisioning, the method comprising:
receiving a provisioning request to provision resources from a plurality of resource pools, wherein the provisioning request includes plural user-specified parameters;
determining state data about the plurality of resource pools by using an API (Application Programming Interface) that interfaces with the plurality of resource pools;
determining the resource pools that can satisfy the provisioning request based upon the state data and how efficiently each of the resource pools satisfy the specified provisioning parameters; and
provisioning resources on a resource pool that has been determined capable of satisfying the provisioning request.

14. The method of claim 13 wherein provisioning resources on a resource pool allocates an amount of resource from the resource pool that is capable of satisfying the provisioning request.

15. The method of claim 13 further comprise ranking the resource pools according to how well the resource pools satisfy the provisioning request.
